(19) United States
(12) Patent Application Publication
(10) Pub. No.: US 2024/0104209 A1
(43) Pub. Date: Mar. 28, 2024

(54) MEMORY DEVICE FOR PERFORMING TARGET REFRESH OPERATION AND OPERATING METHOD THEREOF

(71) Applicant: SK hynix Inc., Gyeonggi-do (KR)

(72) Inventors: Jeong Jin HWANG, Gyeonggi-do (KR); Chul Moon JUNG, Gyeonggi-do (KR)

(21) Appl. No.: 18/453,321

(22) Filed: Aug. 22, 2023

(30) Foreign Application Priority Data
Sep. 23, 2022 (KR) 10-2022-0120482
Jun. 30, 2023 (KR) 10-2023-0085190

(51) Int. Cl. G06F 21/56; G06F 21/55

(52) U.S. Cl. CPC G06F 21/566; G06F 21/554; G06F 2221/034

(57) ABSTRACT

A memory device includes a memory cell region including a plurality of rows; a row-hammer control circuit including first and second queues, and configured to: read counting data from a row indicated by a row address according to an active command, store the row address in the first queue according to a comparison result of the counting data and a first set value, store the row address in the second queue according to a comparison result of the counting data and a second set value, and select, as a row-hammer address according to a refresh management command or a target refresh command, one of the row addresses stored in the first queue and the second queue; and a row control circuit configured to refresh one or more rows corresponding to the row-hammer address according to the refresh management command or the target refresh command.

### CROSS-REFERENCE TO RELATED APPLICATION

The present application claims priority under 35 U.S.C. § 119(a) to Korean Patent Application No. 10-2022-0120482, filed on Sep. 23, 2022, and Korean Patent Application No. 10-2023-0085190, filed on Jun. 30, 2023, which are both incorporated herein by reference in their entirety.

### BACKGROUND

### 1. Field

Various embodiments of the present invention relate to semiconductor design technology, and more particularly, to a memory system including a memory device performing a target refresh operation for row-hammer mitigation.

### 2. Description of the Related Art

In addition to a normal refresh operation, an additional refresh operation which will be, hereinafter, referred to as a ‘target refresh operation’, is being performed on the memory cells of a specific word line that is likely to lose data due to a row-hammer phenomenon. The row-hammer phenomenon refers to a phenomenon in which data of memory cells coupled to a specific word line or the word lines disposed adjacent to the word line are damaged due to a high number of activations of the corresponding word line. In order to prevent the row-hammer phenomenon, a target refresh operation is performed on a word line that is activated more than a predetermined number of times and word lines disposed adjacent to the word line.

Recently, a memory controller has provided a refresh command (hereinafter, referred to as a refresh management command) to a memory device to instruct a target refresh operation, in addition to a normal refresh command that instructs to perform a normal refresh operation. Accordingly, a method of efficiently performing a target refresh operation by a memory device has been studied.

### SUMMARY

Embodiments of the present invention are directed to a memory device capable of selecting a row-hammer address by managing a first queue and a second queue based on counting values obtained by counting the number of accesses to each row.

According to an embodiment of the present invention, a memory device includes a memory cell region including a plurality of rows; a row-hammer control circuit including first and second queues, and configured to: read counting data from a row indicated by a row address according to an active command, store the row address in the first queue according to a comparison result of the counting data and a first set value, store the row address in the second queue according to a comparison result of the counting data and a second set value, and select, as a row-hammer address according to a refresh management command or a target refresh command, one of the row addresses stored in the first queue and the second queue; and a row control circuit configured to refresh one or more rows corresponding to the row-hammer address according to the refresh management command or the target refresh command.

According to an embodiment of the present invention, an operating method of a memory device includes reading counting data from a row indicated by a row address according to an active command; updating the counting data as a first set value and storing the row address into a first queue, when a value of the counting data is greater than the first set value; storing the row address into a second queue when the value of the counting data is less than or equal to the first set value but greater than or equal to a second set value; and refreshing, according to a refresh management command or a target refresh command, one or more rows corresponding to a selected row address of the row addresses stored in the first queue and the second queue.

According to an embodiment of the present invention, an operating method of a memory device includes reading counting data from a row indicated by a row address according to an active command; storing the row address into a second queue when a value of the counting data is greater than or equal to a second set value; updating the counting data as a first set value and storing the row address into a first queue, when the value of the counting data is less than the second set value but greater than the first set value; and refreshing, according to a refresh management command or a target refresh command, one or more rows corresponding to one of the row addresses stored in the first queue and the second queue.

According to an embodiment of the present invention, an operating method of a memory device includes reading counting data from a row indicated by a row address according to an active command; updating the counting data as a first set value and storing the row address into a first queue, when a value of the counting data is greater than the first set value; storing the row address into a second queue when the value of the counting data is greater than or equal to a second set value; and refreshing, according to a refresh management command or a target refresh command, one or more rows corresponding to one of the row addresses stored in the first queue and the second queue.

According to an embodiment of the present invention, a memory system includes a memory controller configured to provide an active command with a row address, or a normal refresh command, or a refresh management command; and a memory device configured to: read counting data from a row indicated by the row address according to the active command, store the row address in a first queue according to a comparison result of the counting data and a first set value, store the row address in a second queue according to a comparison result of the counting data and a second set value, and refresh, according to a refresh management command or a target refresh command, one or more rows corresponding to one of the row addresses stored in the first queue and the second queue.

According to embodiments of the present invention, the memory device may improve a defense capability against a row-hammer attack while minimizing power consumption.

### BRIEF DESCRIPTION OF THE DRAWINGS

FIG. 1 is a block diagram illustrating a memory device in accordance with an embodiment of the present invention.

FIG. 2 is a timing diagram for describing an operation of an internal signal generation circuit of FIG. 1.

FIG. 3 is a block diagram illustrating a row-hammer control circuit of FIG. 1 in accordance with an embodiment of the present invention.

FIG. 4A is a configuration diagram illustrating a first queue of FIG. 3.

FIG. 4B is a configuration diagram illustrating a second queue of FIG. 3.

FIG. 5 is a detailed block diagram illustrating a row-hammer control circuit in accordance with a first embodiment of the present invention.

FIGS. 6A and 6B are flowcharts for describing an operation of a memory device including the row-hammer control circuit of FIG. 5.

FIG. 7 is a detailed block diagram illustrating a row-hammer control circuit in accordance with a second embodiment of the present invention.

FIGS. 8A and 8B are flowcharts for describing an operation of a memory device including the row-hammer control circuit of FIG. 7.

FIG. 9 is a detailed block diagram illustrating a row-hammer control circuit in accordance with a third embodiment of the present invention.

FIG. 10 is a flowchart for describing an operation of a memory device including the row-hammer control circuit of FIG. 9.

FIG. 11 is a block diagram illustrating a memory system in accordance with an embodiment of the present invention.

### DETAILED DESCRIPTION

Various embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout this disclosure, like reference numerals refer to like parts throughout the various figures and embodiments of the present invention.

It will be understood that when an element is referred to as being “coupled” or “connected” to another element, it may mean that the two are directly coupled or the two are electrically connected to each other with another circuit intervening therebetween. It will be further understood that the terms “comprise”, “include”, “have”, etc. when used in this specification, specify the presence of stated features, numbers, steps, operations, elements, components, and/or combinations of them but do not preclude the presence or addition of one or more other features, numbers, steps, operations, elements, components, and/or combinations thereof. In the present disclosure, the singular forms are intended to include the plural forms as well, unless the context clearly indicates otherwise.

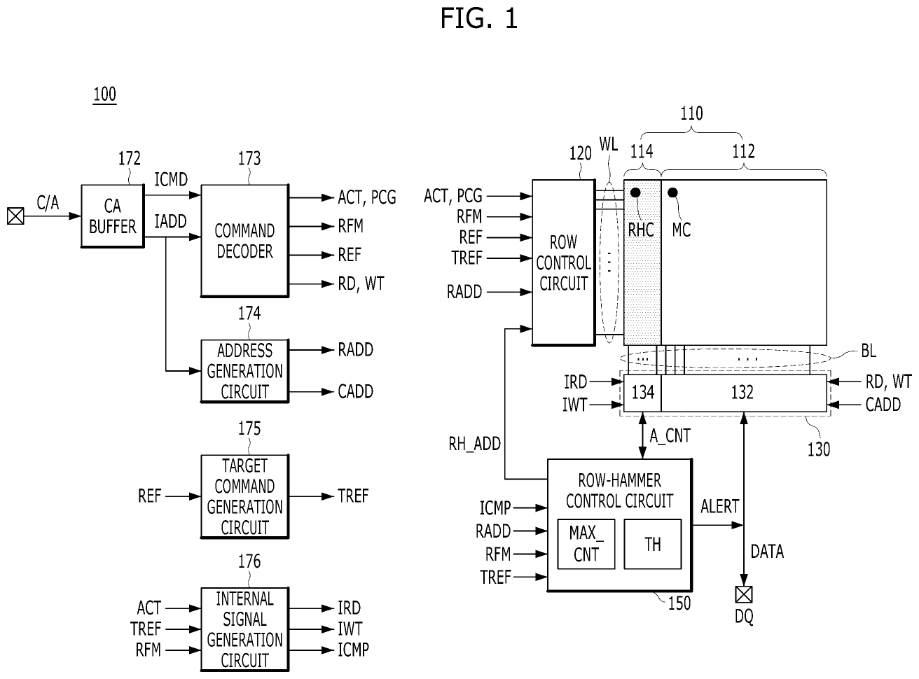

FIG. 1 is a block diagram illustrating a memory device 100 in accordance with an embodiment of the present invention.

Referring to FIG. 1, the memory device 100 may include a memory cell region 110, a row control circuit 120, a column control circuit 130, a row-hammer control circuit 150, a command/address (CA) buffer 172, a command decoder 173, an address generation circuit 174, a target command generation circuit 175, and an internal signal generation circuit 176.

The memory cell region 110 may include a plurality of memory cells MC and RHC respectively coupled to a plurality of word lines WL (hereinafter, referred to “a plurality of rows”) and a plurality of bit lines BL (hereinafter, referred to “a plurality of columns”). The plurality of rows WL may extend in a first direction (e.g., a row direction) and may be sequentially disposed in a second direction (e.g., a column direction). The plurality of columns BL may extend in the column direction and may be sequentially disposed in the row direction. The plurality of memory cells MC and RHC may be composed of memory cells that require a refresh operation to secure data retention time. The memory cell region 110 may be composed of at least one bank. The number of banks or the number of memory cells MC and RHC may be determined depending on the capacity of the memory device 100.

In accordance with an embodiment, the memory cell region 110 may be divided into a normal cell region 112 and a row-hammer (RH) cell region 114. A plurality of normal cells MC may be arranged in an array type in the normal cell regions 112, and a plurality of row-hammer cells RHC may be arranged in an array type in the row-hammer cell region 114. The plurality of normal cells MC and the plurality of row-hammer cells RHC may be coupled to each of the rows WL. The plurality of normal cells MC may store normal data including user data, and the plurality of row-hammer cells RHC may store counting data A_CNT for storing the number of accesses to a corresponding row.

The CA buffer 172 may receive a command/address signal C/A from an external device (e.g., a memory controller). The CA buffer 172 may buffer the command/address signal C/A to output an internal command ICMD and an internal address IADD.

The command decoder 173 may decode the internal command ICMD which is output from the CA buffer 172 to generate an active command ACT, a precharge command PCG, a read command RD, and a write command WT. Further, the command decoder 173 may decode the internal command ICMD to generate a normal refresh command as a periodic refresh command, and a refresh management command as a non-periodic refresh command.

The address generation circuit 174 may classify the internal address IADD received from the CA buffer 172 as a row address RADD and a column address CADD. Depending on an embodiment, the address generation circuit 174 may classify some bits of the internal address IADD as a row address RADD and classify the remaining bits as a column address CADD. The address generation circuit 174 may classify the internal address IADD as a row address RADD when an active operation is directed as a result of the decoding by the command decoder 173 and may classify the internal address IADD as a column address CADD when a read or write operation is directed. The plurality of rows WL may be accessed by the row address RADD, and the plurality of columns BL may be accessed by the column address CADD.

The target command generation circuit 175 may generate a target refresh command TREF whenever the number of inputs of the normal refresh command REF reaches a predetermined number of times or reaches a certain condition. That is, the refresh management command RFM may be a command provided from the memory controller for a target refresh operation, and the target refresh command TREF may be a command generated by the memory device 100 itself for the target refresh operation.

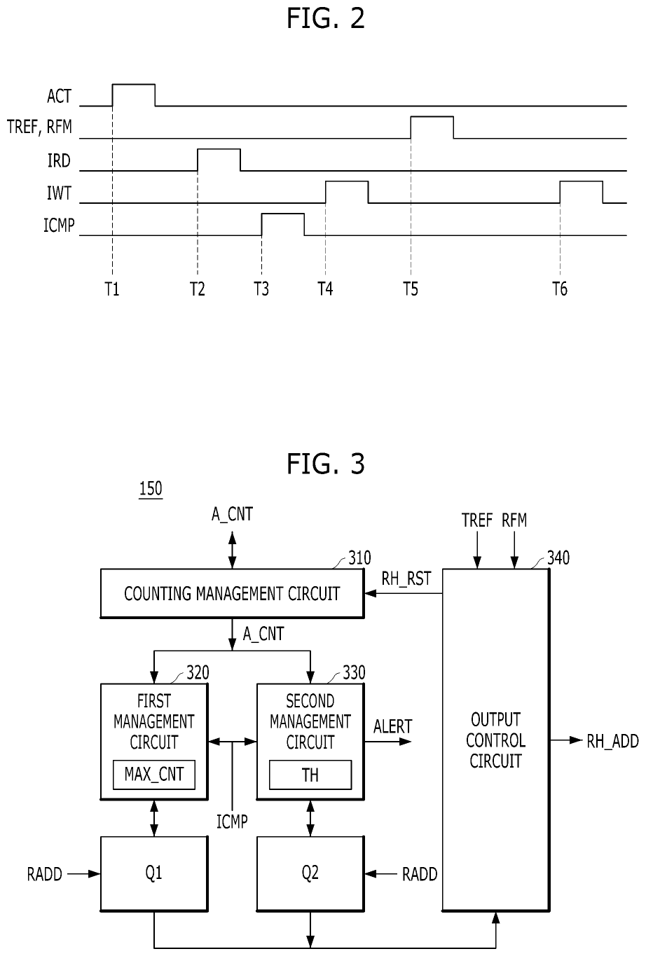

The internal signal generation circuit 176 may sequentially generate an internal read signal IRD, an internal comparison signal ICMP, and an internal write signal IWT when the active command ACT is input. When the refresh management command RFM or the target refresh command TREF is input, the internal signal generation circuit 176 may generate the internal write signal IWT to initialize the row-hammer cells RHC of a target row. For example, referring to FIG. 2, when the active command ACT is input at a time of T1, the internal signal generation circuit 176 may generate the internal read signal IRD at a time of T2. After that, the internal signal generation circuit 176 may generate the internal comparison signal ICMP at a time of T3 and generate the internal write signal IWT at a time of T4. In addition, when the refresh management command RFM or the target refresh command TREF is input at a time of T5, the internal signal generation circuit 176 may generate the internal write signal IWT at a time of T6.

Referring back to FIG. 1, the row control circuit 120 may be coupled to the normal cells MC in the normal cell regions 112 and the row-hammer cells RHC in the row-hammer cell region 114, through the rows WL. The row control circuit 120 may select or activate at least one row selected by the row address RADD when the active command ACT is input and deactivate the activated row when the precharge command PCG is input. In order to select a row to be refreshed during a normal refresh operation, a refresh counter (not shown) for generating a counting address that is sequentially increasing according to a normal refresh command REF may be additionally provided. The row control circuit 120 may perform a normal refresh operation of sequentially refreshing a plurality of rows WL corresponding to the counting address when the normal refresh command REF is input. The row control circuit 120 may perform a target refresh operation of refreshing one or more neighboring rows of a target row indicated by a row-hammer address RH_ADD when the refresh management command RFM or the target refresh command TREF is input.

The column control circuit 130 may include a first column control circuit 132 corresponding to the normal cell regions 112, and a second column control circuit 134 corresponding to the row-hammer cell region 114. The first column control circuit 132 and the second column control circuit 134 may be coupled to the normal cells MC of the normal cell regions 112 and the row-hammer cells RHC of the row-hammer cell region 114, respectively through the separated columns BL.

The first column control circuit 132 may select some columns among the columns BL, according to the column address CADD, read out the normal data DATA from the normal cells MC through the selected columns in response to the read command RD, and write the normal data DATA provided from the outside into the normal cells MC through the selected columns in response to the write command WT. The first column control circuit 132 may be coupled to a data pad DQ to transmit and receive the normal data DATA to and from the memory controller.

The second column control circuit 134 may read out the counting data A_CNT from the row-hammer cells RHC of the row-hammer cell region 114, to output the read counting data A_CNT to the row-hammer control circuit 150, according to the internal read signal IRD. The second column control circuit 134 may receive updated counting data A_CNT from the row-hammer control circuit 150 to write back the updated counting data A_CNT to the row-hammer cells RHC of the row-hammer cell region 110_2, according to the internal write signal IWT.

The row-hammer control circuit 150 may update the counting data A_CNT when the counting data A_CNT are read from the row-hammer cells RHC according to the internal read signal IRD activated when the active command ACT is input. For example, the row-hammer control circuit 150 may increase a value of the counting data A_CNT by “+1”. The row-hammer control circuit 150 may provide the updated counting data A_CNT to the second column control circuit 134. The second column control circuit 134 may write back the updated counting data A_CNT to the row-hammer cells RHC according to the internal write signal IWT activated when the active command ACT is input.

In addition, the row-hammer control circuit 150 may sample the row address RADD based on the counting data A_CNT, and when the refresh management command RFM or the target refresh command TREF is input, select one of the sampled addresses as the row-hammer address RH_ADD. The row-hammer control circuit 150 may initialize the counting data A_CNT to a specific value (e.g., an all-zero value) after the row-hammer address RH_ADD is output. When the refresh management command RFM or the target refresh command TREF is input, the second column control circuit 134 may write back the initialized counting data A_CNT to the row-hammer cells RHC according to the internal write signal IWT.

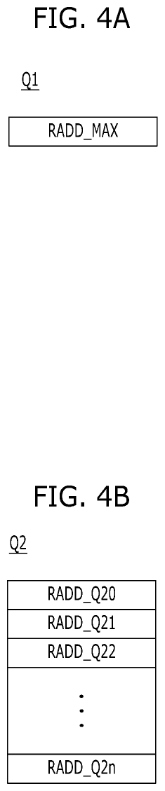

In an embodiment of the present invention, the row-hammer control circuit 150 may include a first queue (Q1 in FIG. 3) and a second queue (Q2 in FIG. 3). The row-hammer control circuit 150 may store a corresponding row address in the first queue Q1 according to a comparison result of the counting data A_CNT and a first set value MAX_CNT, and store a corresponding row address in the second queue Q2 according to a comparison result of the counting data A_CNT and a second set value TH. In this case, the first set value MAX_CNT may be determined based on the largest value (i.e., a maximum value) among the counting data A_CNT of the plurality of rows WL. The first set value MAX_CNT may be updated when the active command ACT is input. The first queue Q1 may be configured as a single field for storing a row address corresponding to the maximum value. The second set value TH may be set to a value greater than or equal to the first set value MAX_CNT, a value less than the first set value MAX_CNT, or any value unrelated to the first set value MAX_CNT. The second queue Q2 may be configured with a plurality of fields for storing a plurality of row addresses corresponding to counting data equal to or greater than the second set value TH.

More specifically, when the active command ACT is input, the row-hammer control circuit 150 may compare the counting data A_CNT with the first set value MAX_CNT according to the internal comparison signal ICMP. When the value of the counting data A_CNT is greater than the first set value MAX_CNT, the row-hammer control circuit 150 may store (i.e., update) the counting data A_CNT as the first set value MAX_CNT and store the row address RADD into the first queue Q1. Further, the row-hammer control circuit 150 may compare the counting data A_CNT with the second set value TH according to the internal comparison signal ICMP. When the value of the counting data A_CNT is greater than or equal to the second set value TH, a new field may be inserted into the second queue Q2 and the row address may be stored in the inserted field of the second queue Q2. Hereinafter, the first set value MAX_CNT is defined as a maximum value MAX_CNT, and the second set value TH is defined as a specific threshold value TH.

The row-hammer control circuit 150 may generate an alert signal ALERT when the second queue Q2 is full. In this case, when the second queue Q2 is full, it may mean a state in which all fields are generated by a set depth of the second queue Q2. The alert signal ALERT may be provided to the memory controller through an internal data bus that transmits the normal data DATA between the first column control circuit 132 and the data pad DQ. The memory controller may issue the refresh management command RFM every preset time, or issue the refresh management command RFM every time the number of issuances of the active command ACT reaches a preset number and provide the refresh management command RFM to the memory device 100 as the command/address signal C/A. The memory controller may additionally issue the refresh management command RFM according to the alert signal ALERT. Depending on a configuration, the memory controller may receive depth information on the set depth of the queue Q2 in advance from the memory device 100 and, when the alert signal ALERT is input, provide the refresh management commands RFM to the memory device 100 sequentially as many times as determined by the depth information. For example, the memory controller may provide the refresh management commands RFM less than or equal to the depth of the queue Q2. When the refresh management command RFM or the target refresh command TREF is input, the row-hammer control circuit 150 may select, as the row-hammer address RH_ADD, one of the row addresses stored in the first queue Q1 and the second queue Q2.

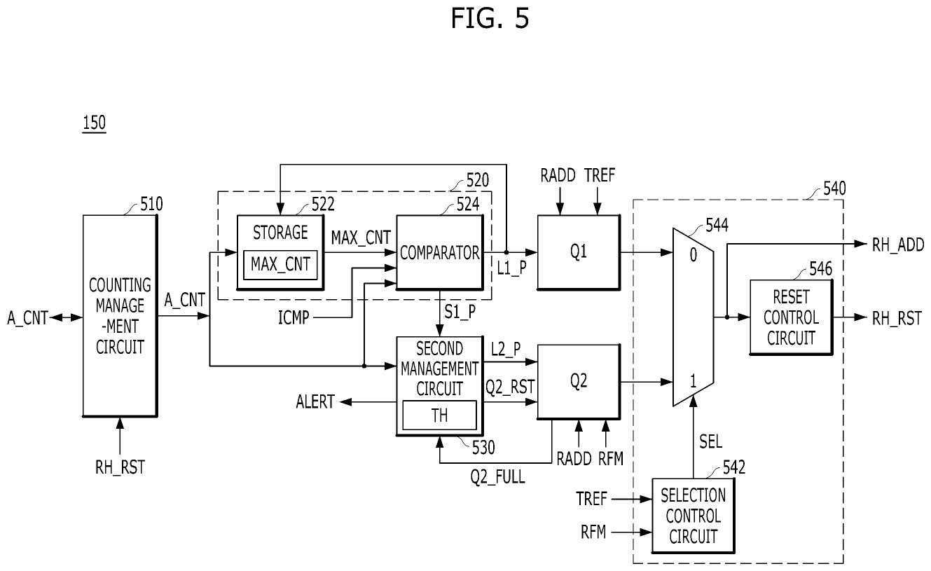

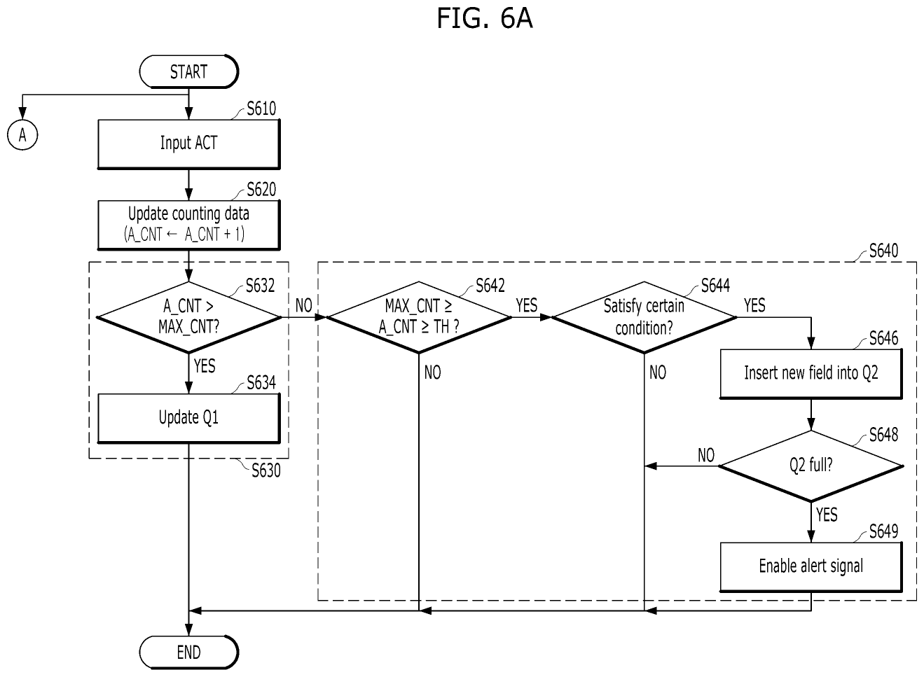

FIG. 3 is a block diagram illustrating the row-hammer control circuit 150 of FIG. 1 in accordance with an embodiment of the present invention. FIG. 4A is a configuration diagram illustrating the first queue Q1 of FIG. 3. FIG. 4B is a configuration diagram illustrating the second queue Q2 of FIG. 3.

Referring to FIG. 3, the row-hammer control circuit 150 may include a counting management circuit 310, the first queue Q1, the second queue Q2, a first management circuit 320, a second management circuit 330, and an output control circuit 340.

The counting management circuit 310 may update the counting data A_CNT read from the row-hammer cells RHC by increasing the value of the counting data A_CNT by “+1”. The counting management circuit 310 may provide the updated counting data A_CNT to the second column control circuit 134, the first management circuit 320, and the second management circuit 330. The counting management circuit 310 may initialize the counting data A_CNT according to a counting reset signal RH_RST.

The first management circuit 320 may manage the first queue Q1 based on the counting data A_CNT. The first management circuit 320 may store the maximum value MAX_CNT and compare the counting data A_CNT with the pre-stored maximum value MAX_CNT according to the internal comparison signal ICMP. The first management circuit 320 may store (i.e., update) the counting data A_CNT as the maximum value MAX_CNT when the value of the counting data A_CNT is greater than the maximum value MAX_CNT. The first management circuit 320 may control the row address RADD corresponding to the updated maximum value MAX_CNT to be stored as a first sampling address in the field of the first queue Q1.

Referring to FIG. 4A, the first queue Q1 may include a single field that stores a row address (i.e., a first sampling address) RADD_MAX corresponding to the maximum value MAX_CNT. That is, the depth of the first queue Q1 may be set to 1.

Referring back to FIG. 3, the second management circuit 330 may manage the second queue Q2 based on the counting data A_CNT. The second management circuit 330 may compare the counting data A_CNT with a pre-stored specific threshold value TH according to the internal comparison signal ICMP. The second management circuit 330 may insert a new field into the second queue Q2 when the value of the counting data A_CNT is greater than or equal to the specific threshold TH and control the row address RADD corresponding to the counting data A_CNT to be stored as one of a plurality of second sampling addresses in the inserted field. When the second queue Q2 is full, the second management circuit 330 may generate the alert signal ALERT and provide the generated alert signal ALERT to the memory controller.

Referring to FIG. 4B, the second queue Q2 may include a number of fields that store a plurality of row addresses (that is, a second sampling address) RADD_Q2 # (# is an integer from 0 to n) corresponding to the counting data A_CNT. FIG. 4B shows a case where the depth of the second queue Q2 is set to (n+1), and (n+1) fields are included in the second queue Q2.

Referring back to FIG. 3, the output control circuit 340 may select, as the row-hammer address RH_ADD, one of the first sampling address RADD_MAX stored in the first queue Q1 and the second sampling address RADD_Q2 # stored in the second queue Q2, according to the refresh management command RFM or the target refresh command TREF. In addition, the output control circuit 340 may activate the counting reset signal RH_RST after the row-hammer address RH_ADD is output. Accordingly, the counting management circuit 310 may initialize the counting data A_CNT after the row-hammer address RH_ADD is output.

According to an embodiment, the output control circuit 340 may output the first sampling address RADD_MAX stored in the first queue Q1 as the row-hammer address RH_ADD when the target refresh command TREF is input and may output one of the second addresses RADD_Q2 # as the row-hammer address RH_ADD when the target refresh command RFM is input. According to an embodiment, when the target refresh command RFM is input, the output control circuit 340 may output the first sampling address RADD_MAX stored in the first queue Q1 as the row-hammer address RH_ADD if the second queue Q2 is empty, but output one of the second sampling addresses RADD_Q2 # stored in the second queue Q2 as the row-hammer address RH_ADD if the second queue Q2 is not empty. The output control circuit 340 may sequentially output the second sampling addresses RADD_Q2 # as the row-hammer address RH_ADD according to a first-in-first-out (FIFO) scheme.

Hereinafter, a method of managing the first queue Q1 and the second queue Q2 will be described in detail with reference to first to third embodiments of the present invention.

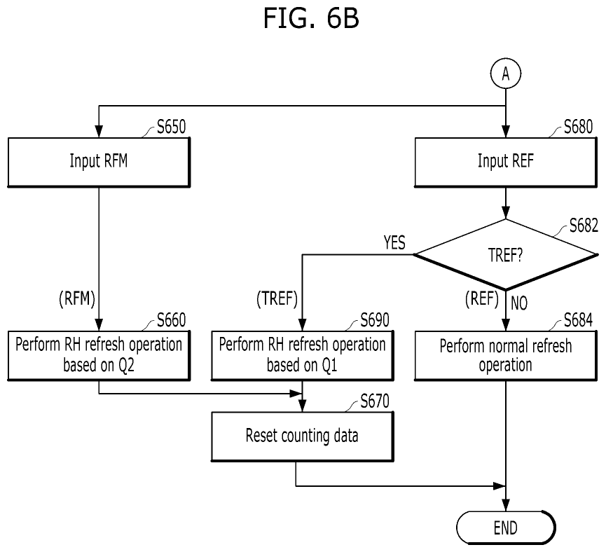

FIG. 5 is a detailed block diagram illustrating the row-hammer control circuit 150 in accordance with a first embodiment of the present invention. In the first embodiment of the present invention, the configuration of the row-hammer control circuit 150 is described when an operation of a first management circuit is preferentially performed according to a comparison result of the counting data A_CNT and the maximum value MAX_CNT.

Referring to FIG. 5, the row-hammer control circuit 150 may include a counting management circuit 510, a first queue Q1, a second queue Q2, a first management circuit 520, a second management circuit 530, and an output control circuit 540.

The counting management circuit 510 may update the counting data A_CNT read from the row-hammer cells RHC by increasing the value of the counting data A_CNT by “+1”. The counting management circuit 510 may provide the updated counting data A_CNT to the second column control circuit 134, the first management circuit 520, and the second management circuit 530. The counting management circuit 510 may initialize the counting data A_CNT according to a counting reset signal RH_RST.

The first management circuit 520 may include a storage 522 and a comparator 524.

The storage 522 may store the counting data A_CNT as the maximum value MAX_CNT according to a first comparison decision signal L1_P. The storage 522 may provide the stored maximum value MAX_CNT to the comparator 524. The comparator 524 may compare the value of the counting data A_CNT with the maximum value MAX_CNT according to the internal comparison signal ICMP. The comparator 524 may activate the first comparison decision signal L1_P when the value of the counting data A_CNT is greater than the maximum value MAX_CNT and activate a second comparison decision signal S1_P when the value of the counting data A_CNT is less than or equal to the maximum value MAX_CNT.

The first queue Q1 may store the row address RADD into its field, as the first sampling address RADD_MAX, according to the first comparison decision signal L1_P. That is, when the first comparison decision signal L1_P is activated, the first queue Q1 may update its field using the row address. The first queue Q1 may initialize its field according to the target refresh command TREF.

The second management circuit 530 may compare the value of counting data A_CNT with the pre-stored specific threshold value TH according to the second comparison decision signal S1_P. When the value of the counting data A_CNT is greater than or equal to the specific threshold value TH, the second management circuit 530 may increase an internal counting value by “+1” and check whether the internal counting value satisfies a predetermined condition. In this case, the predetermined condition may be a preset number of times that is variously set as specific integers (e.g., 2, 3, 4, etc.), a multiple of a specific integer (e.g., a multiple of 2, a multiple of 3, etc.), and the like. The second management circuit 530 may activate a third comparison decision signal L2_P when the internal counting value satisfies the predetermined condition. The second management circuit 530 may generate the alert signal ALERT according to a full-state signal Q2_FULL provided from the second queue Q2. In addition, the second management circuit 530 may generate a queue reset signal Q2_RST after a refresh time (tREF) from the insertion of a first field into the second queue Q2. For example, the second management circuit 530 may have a timer that is triggered as the first field is inserted into the second queue Q2 to generate the queue reset signal Q2_RST after the refresh time (tREF).

The second queue Q2 may insert a new field and store the row address RADD as one of the second sampling addresses RADD_Q2 # in the inserted field, according to the third comparison decision signal L2_P. That is, when the third comparison decision signal L2_P is activated, the second queue Q2 may update its field. In addition, the second queue Q2 may initialize all fields according to the queue reset signal Q2_RST, or only a certain field according to the refresh management command RFM. The second queue Q2 may generate the full-state signal Q2_FULL when all fields are generated as much as the set depth and become full.

The output control circuit 540 may include a selection control circuit 542, a selection circuit 544, and a reset control circuit 546.

The selection control circuit 542 may generate a selection signal SEL that becomes a logic high level when the refresh management command RFM is input and a logic low level when the target refresh command TREF is input. The selection circuit 544 may select, as the row-hammer address RH_ADD, one of the row address stored in the first queue Q1 and the row addresses stored in the second queue Q2 according to the selection signal SEL. The selection circuit 544 may select the row address stored in the first queue Q1 if the selection signal SEL is at a logic low level and may select one of the row addresses stored in the second queue Q2 if the selection signal SEL is at a logic high level. The reset control circuit 546 may activate the counting reset signal RH_RST after the row-hammer address RH_ADD is output.

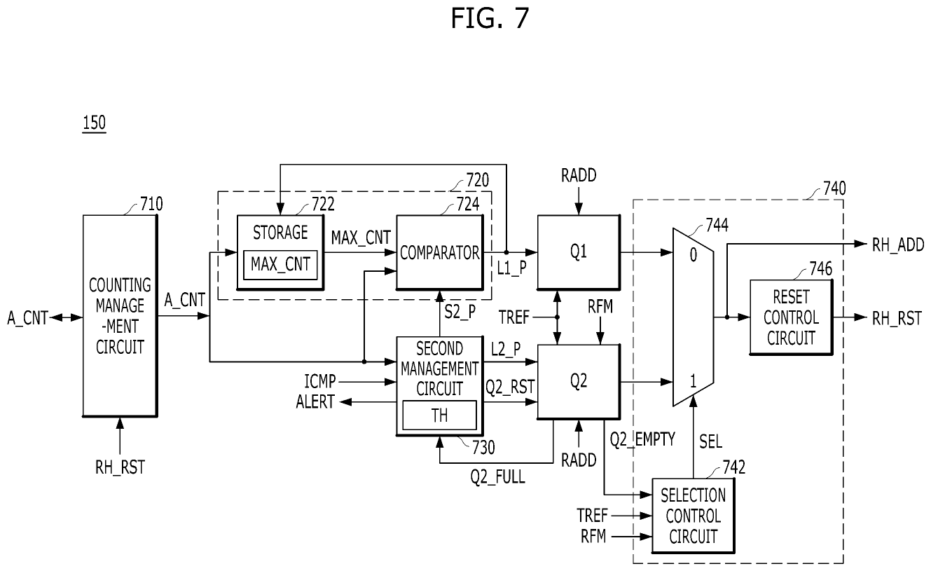

Hereinafter, a method of managing the first queue Q1 and the second queue Q2 according to the first embodiment will be described with reference to FIGS. 5 to 6B.

FIGS. 6A and 6B are flowcharts for describing an operation of the memory device 100 including the row-hammer control circuit 150 of FIG. 5.

Referring to FIG. 6A, the active command ACT is input (at S610). In this case, the row address RADD may be input together with the active address ACT. The internal signal generation circuit 176 may sequentially generate the internal read signals IRD, the internal comparison signal ICMP, and the internal write signals IWT according to the active command ACT.

The row control circuit 120 may activate a row indicated by the row address RADD according to the active command ACT, and the second column control circuit 134 may read the counting data A_CNT from the row-hammer cells RHC coupled to the activated row according to the internal read signal IRD. The counting management circuit 510 of the row-hammer control circuit 150 may update the counting data A_CNT by increasing the value of the counting data A_CNT by “+1” (at S620). After that, the second column control circuit 134 may write back the updated counting data A_CNT to the row-hammer cells RHC in the row indicated by the row address RADD, according to the internal write signal IWT.

The first management circuit 520 may manage the first queue Q1 according to the counting data A_CNT (at S630).

In detail, the first management circuit 520 may compare the counting data A_CNT with the maximum value MAX_CNT according to the internal comparison signal ICMP (at S632). When the value of the counting data A_CNT is greater than the maximum value MAX_CNT (“YES” in S632), the first management circuit 520 may activate the first comparison decision signal L1_P, and accordingly, the first queue Q1 may update the field by storing the input row address RADD (at S634). In addition, the first management circuit 520 may update the counting data A_CNT as the maximum value MAX_CNT according to the first comparison decision signal L1_P. Thereafter, the operation may be terminated without an additional update operation of the second management circuit 530.

When the value of the counting data A_CNT is less than or equal to the maximum value MAX_CNT (“NO” in S632), the first management circuit 520 may activate the second comparison decision signal S1_P, and accordingly, the second management circuit 530 may manage the second queue Q2 according to the counting data A_CNT (at S640).

In detail, the second management circuit 530 may compare the counting data A_CNT with the specific threshold value TH according to the second comparison decision signal S1_P (at S642). When the value of the counting data A_CNT is less than the specific threshold value TH (“NO” in S642), the operation may be terminated without an additional update operation of the first management circuit 520 and the second management circuit 530. On the other hand, when the value of the counting data A_CNT is less than or equal to the maximum value MAX_CNT but greater than or equal to the specific threshold value TH (“YES” in S642), the second management circuit 530 may increase the internal counting value by “+1” and check whether the internal counting value satisfies a predetermined condition (at S644). When it is determined that the internal counting value does not satisfy the predetermined condition (“NO” in S644), the operation may be terminated without the additional update operation. On the other hand, when it is determined that the internal counting value satisfies the predetermined condition (“YES” in S644), the second management circuit 530 may activate the third comparison decision signal L2_P. For example, whenever the internal counting value reaches a predetermined number of times, the second management circuit 530 may activate the third comparison decision signal L2_P. Accordingly, the second queue Q2 may insert a new field and store the row address RADD input to the inserted field as one of the second sampling addresses RADD_Q2 # (at S646).

At this time, when the second queue Q2 is full (“YES” in S648), the second queue Q2 may activate the full-state signal Q2_FULL, and accordingly, the second management circuit 530 may generate the alert signal ALERT (at S649). The alert signal ALERT may be provided to the memory controller through the internal data bus. The memory controller may issue the refresh management command RFM every preset time or provide the refresh management command RFM every time the number of issuances of the active command ACT reaches a preset number. In addition, in an embodiment of the present invention, the memory controller may provide the refresh management command RFM to the memory device 100 according to the alert signal ALERT.

Referring to FIG. 6B, the refresh management command RFM is input (at S650). The output control circuit 540 may output one of the second sampling addresses RADD_Q2 # stored in the second queue Q2 as the row-hammer address RH_ADD according to the refresh management command RFM (at S660). After that, the second queue Q2 may initialize a field in which the second sampling address output according to the refresh management command RFM is stored. The row control circuit 120 may perform a target refresh operation to refresh one or more adjacent rows corresponding to the row-hammer address RH_ADD according to the refresh management command RFM (at S660). After the row-hammer address RH_ADD is output, the output control circuit 540 may activate the counting reset signal RH_RST, and the counting management circuit 510 may initialize the counting data A_CNT (at S670). The second column control circuit 134 may write back the initialized counting data A_CNT to the row-hammer cells RHC in the row indicated by the row-hammer address RH_ADD, according to the internal write signal IWT.

Meanwhile, the memory controller may provide refresh management commands RFM to the memory device 100 as many times as the depth of the queue Q2 according to the alert signal ALERT. As the refresh management command RFM is input, the above operations of S650 to S670 are repeatedly performed, and the second sampling addresses RADD_Q2 # stored in the second queue Q2 are sequentially outputted as the row-hammer address RH_ADD to perform the target refresh operation. After all of the second sampling addresses RADD_Q2 # stored in the second queue Q2 are output, the second queue Q2 may be initialized.

On the other hand, when the normal refresh command REF is input (“NO” of S680 & S682), the row control circuit 120 may perform a normal refresh operation that sequentially refreshes the plurality of rows WL (at S684).

The target command generation circuit 175 may generate the target refresh command TREF whenever the number of inputs of the normal refresh command REF reaches a predetermined number of times or reaches a certain condition (“YES” in S682). The output control circuit 540 may output the first sampling address RADD_MAX stored in the first queue Q1 as the row-hammer address RH_ADD according to the target refresh command TREF (at S690). Thereafter, the first queue Q1 may initialize the field according to the target refresh command TREF. The row control circuit 120 may perform a target refresh operation to refresh one or more adjacent rows corresponding to the row-hammer address RH_ADD according to the target refresh command TREF (at S690). After the row-hammer address RH_ADD is output, the output control circuit 540 may activate the counting reset signal RH_RST, and the counting management circuit 510 may initialize the counting data A_CNT (at S670). The second column control circuit 134 may write back the initialized counting data A_CNT to the row-hammer cells RHC in the row indicated by the row-hammer address RH_ADD, according to the internal write signal IWT.

For reference, since all rows are refreshed by the normal refresh operation, there is no need to perform a separate target refresh operation on the rows (or adjacent rows) corresponding to the second sampling addresses stored in the second queue Q2. Accordingly, the second queue Q2 may be initialized every refresh time (tREF) after the first field is inserted.

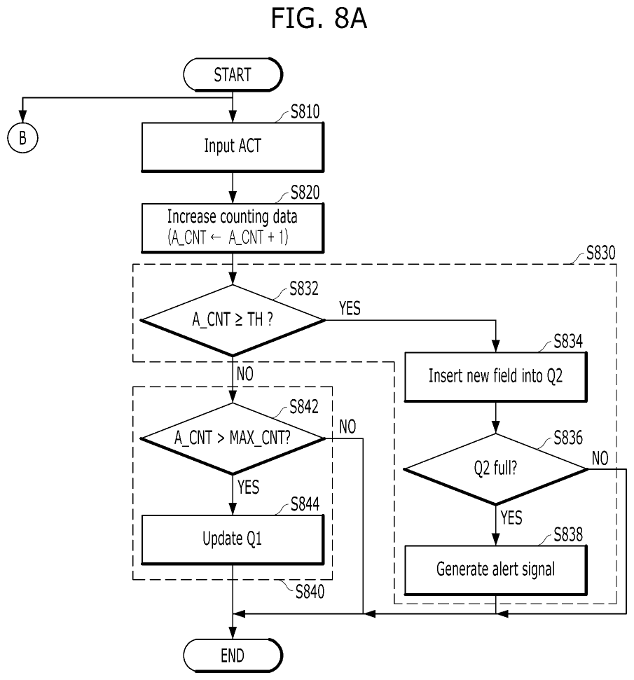

FIG. 7 is a detailed block diagram illustrating the row-hammer control circuit 150 in accordance with a second embodiment of the present invention. In the second embodiment of this invention, the configuration of the row-hammer control circuit 150 is described when an operation of a second management circuit is preferentially performed according to a comparison result of the counting data A_CNT and the specific threshold value TH.

Referring to FIG. 7, the row-hammer control circuit 150 may include a counting management circuit 710, a first queue Q1, a second queue Q2, a first management circuit 720, a second management circuit 730, and an output control circuit 740.

The configuration and operation of the counting management circuit 710, the first queue Q1, the second queue Q2, the first management circuit 720, the second management circuit 730, and the output control circuit 740 of FIG. 7 may be substantially the same as those of FIG. 5. However, there is a difference in that the second management circuit 730 receives the internal comparison signal ICMP instead of the first management circuit 720. Hereinafter, FIG. 7 will be described based on a different configuration from FIG. 5.

The second management circuit 730 may compare the value of counting data A_CNT with the pre-stored specific threshold value TH according to the internal comparison signal ICMP. When the value of the counting data A_CNT is greater than or equal to the specific threshold value TH, the second management circuit 730 may activate a third comparison decision signal L2_P. When the value of the counting data A_CNT is less than the specific threshold value TH, the second management circuit 730 may activate a fourth comparison decision signal S2_P.

The second queue Q2 may insert a new field and store the row address RADD as one of the second sampling addresses RADD_Q2 # in the inserted field, according to the third comparison decision signal L2_P. In addition, the second queue Q2 may initialize all fields according to the queue reset signal Q2_RST, or only a certain field according to the refresh management command RFM or the target refresh command TREF. The second queue Q2 may generate a full-state signal Q2_FULL when all fields are generated as much as the set depth and become full and activate an empty signal Q2_EMPTY after all second sampling addresses RADD_Q2 # stored in the fields are output.

The second management circuit 730 may generate the alert signal ALERT according to the full-state signal Q2_FULL provided from the second queue Q2. In addition, the second management circuit 730 may generate a queue reset signal Q2_RST after a refresh time (tREF) from the insertion of a first field into the second queue Q2. For example, the second management circuit 730 may have a timer that is triggered as the first field is inserted into the second queue Q2 to generate the queue reset signal Q2_RST after the refresh time (tREF).

The first management circuit 720 may include a storage 722 and a comparator 724.

The storage 722 may store the counting data A_CNT as the maximum value MAX_CNT according to a first comparison decision signal L1_P. The comparator 724 may compare the value of the counting data A_CNT with the maximum value MAX_CNT according to the fourth comparison decision signal S2_P. The comparator 724 may activate the first comparison decision signal L1_P when the value of the counting data A_CNT is greater than the maximum value MAX_CNT. The first queue Q1 may store the row address RADD into its field, as the first sampling address RADD_MAX, according to the first comparison decision signal L1_P.

For reference, in the first embodiment, the first management circuit 520 may perform a comparison operation according to the internal comparison signal ICMP, and the second management circuit 530 may selectively perform a comparison operation according to the comparison result (i.e., the second comparison decision signal S1_P) of the first management circuit 720. On the other hand, in the second embodiment, the second management circuit 730 may perform a comparison operation according to the internal comparison signal ICMP, and the first management circuit 720 may selectively perform a comparison operation according to the comparison result (i.e., the fourth comparison decision signal S2_P) of the second management circuit 730.

The output control circuit 740 may include a selection control circuit 742, a selection circuit 744, and a reset control circuit 746.

The selection control circuit 742 may generate a selection signal SEL that becomes a logic high level when the refresh management command RFM is input. The selection control circuit 742 may determine a logic level of the selection signal SEL according to a state of the second queue Q2 when the target refresh command TREF is input. For example, the selection control circuit 742 may generate the selection signal SEL that becomes a logic low level when the target refresh command TREF is input and the empty signal Q2_EMPTY is activated and becomes a logic high level when the target refresh command TREF is input and the empty signal Q2_EMPTY is deactivated.

The selection circuit 744 may select, as the row-hammer address RH_ADD, one of the row address stored in the first queue Q1 and the row addresses stored in the second queue Q2 according to the selection signal SEL. The selection circuit 744 may select the row address stored in the first queue Q1 if the selection signal SEL is at a logic low level and may select one of the row addresses stored in the second queue Q2 if the selection signal SEL is at a logic high level. The reset control circuit 746 may activate the counting reset signal RH_RST after the row-hammer address RH_ADD is output.

The reset control circuit 746 may activate the counting reset signal RH_RST after the row-hammer address RH_ADD is output.

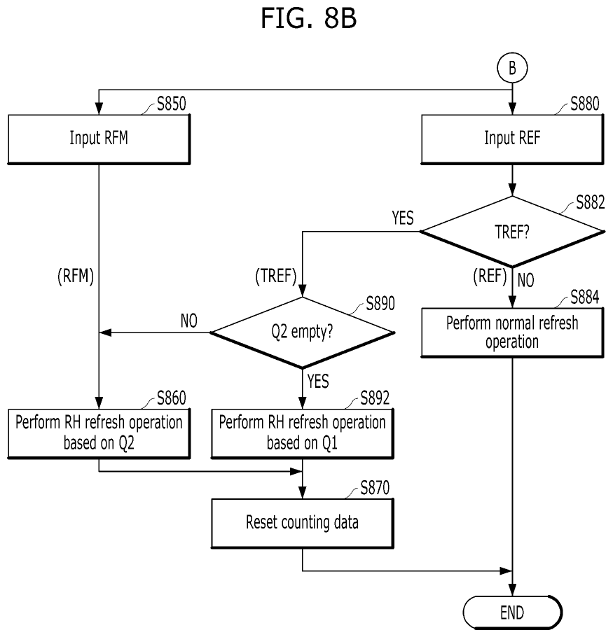

Hereinafter, a method of managing the first queue Q1 and the second queue Q2 according to the second embodiment will be described with reference to FIGS. 7 to 8B.

FIGS. 8A and 8B are flowcharts for describing an operation of the memory device 100 including the row-hammer control circuit 150 of FIG. 7.

Referring to FIG. 8A, the active command ACT is input together with the row address RADD (at S810). The internal signal generation circuit 176 may sequentially generate the internal read signals IRD, the internal comparison signal ICMP, and the internal write signals IWT according to the active command ACT.

The second column control circuit 134 may read the counting data A_CNT from the row-hammer cells RHC coupled to the activated row according to the internal read signal IRD. The counting management circuit 710 of the row-hammer control circuit 150 may update the counting data A_CNT by increasing the value of the counting data A_CNT by “+1” (at S820). After that, the second column control circuit 134 may write back the updated counting data A_CNT to the row-hammer cells RHC in the row indicated by the row address RADD, according to the internal write signal IWT.

The second management circuit 730 may manage the second queue Q2 according to the counting data A_CNT (at S830).

In detail, the second management circuit 730 may compare the counting data A_CNT with the specific threshold value TH according to the internal comparison signal ICMP (at S832). When the value of the counting data A_CNT is greater than or equal to the specific threshold value TH (“YES” in S832), the second management circuit 730 may activate the third comparison decision signal L2_P. Thus, the second queue Q2 may insert a new field and store the row address RADD as one of the second sampling addresses RADD_Q2 # in the inserted field, according to the third comparison decision signal L2_P (at S834). At this time, when the second queue Q2 is full (“YES” in S836), the second queue Q2 may activate the full-state signal Q2_FULL, and accordingly, the second management circuit 730 may generate the alert signal ALERT (at S838). The alert signal ALERT may be provided to the memory controller through the internal data bus.

On the other hand, when the value of the counting data A_CNT is less than the specific threshold value TH (“NO” in S832), the second management circuit 730 may activate the fourth comparison decision signal S2_P, and accordingly, the first management circuit 720 may manage the first queue Q1 according to the counting data A_CNT (at S840).

In detail, the first management circuit 720 may compare the counting data A_CNT with the maximum value MAX_CNT according to the fourth comparison decision signal S2_P (at S842). When the value of the counting data A_CNT is less than the specific threshold value TH and greater than the maximum value MAX_CNT (“YES” in S842), the first management circuit 720 may activate the first comparison decision signal L1_P, and accordingly, the first queue Q1 may update the field by storing the input row address RADD (at S844). In addition, the first management circuit 720 may update the counting data A_CNT as the maximum value MAX_CNT according to the first comparison decision signal L1_P. When the value of the counting data A_CNT is less than or equal to the maximum value MAX_CNT (“NO” in S842), the operation may be terminated without an additional update operation of the first management circuit 720 and the second management circuit 730.

Referring to FIG. 8B, the refresh management command RFM is input (at S850). The output control circuit 740 may output one of the second sampling addresses RADD_Q2 # stored in the second queue Q2 as the row-hammer address RH_ADD according to the refresh management command RFM (at S860). After that, the second queue Q2 may initialize a field in which the second sampling address output according to the refresh management command RFM is stored. The row control circuit 120 may perform a target refresh operation to refresh one or more adjacent rows corresponding to the row-hammer address RH_ADD according to the refresh management command RFM (at S860). After the row-hammer address RH_ADD is output, the output control circuit 740 may activate the counting reset signal RH_RST, and the counting management circuit 710 may initialize the counting data A_CNT (at S870). The second column control circuit 134 may write back the initialized counting data A_CNT to the row-hammer cells RHC in the row indicated by the row-hammer address RH_ADD, according to the internal write signal IWT.

On the other hand, when the normal refresh command REF is input (“NO” in S882), the row control circuit 120 may perform a normal refresh operation that sequentially refreshes the plurality of rows WL (at S884).

The target command generation circuit 175 may generate the target refresh command TREF whenever the number of inputs of the normal refresh command REF reaches a predetermined number of times or reaches a certain condition (“YES” in S882). The output control circuit 740 may select one row address from the row addresses stored in the first queue Q1 and the second queue Q2 according to a state of the second queue Q2 when the target refresh command TREF is input. For example, when the target refresh command TREF is input and the empty signal Q2_EMPTY is activated (“YES” in S890), the output control circuit 740 may output the first sampling address RADD_MAX stored in the first queue Q1 as the row-hammer address RH_ADD (at S892). Thereafter, the first queue Q1 may initialize its field according to the target refresh command TREF. The row control circuit 120 may perform a target refresh operation to refresh one or more adjacent rows corresponding to the row-hammer address RH_ADD according to the target refresh command TREF (at S892). When the target refresh command TREF is input and the empty signal Q2_EMPTY is deactivated (“NO” in S890), the output control circuit 740 may output one of the second sampling addresses RADD_Q2 # stored in the second queue Q2 as the row-hammer address RH_ADD (at S860). The row control circuit 120 may perform a target refresh operation to refresh one or more adjacent rows corresponding to the row-hammer address RH_ADD according to the target refresh command TREF (at S860).

After the row-hammer address RH_ADD is output, the output control circuit 740 may activate the counting reset signal RH_RST, and the counting management circuit 710 may initialize the counting data A_CNT (at S870). The second column control circuit 134 may write back the initialized counting data A_CNT to the row-hammer cells RHC in the row indicated by the row-hammer address RH_ADD, according to the internal write signal IWT.

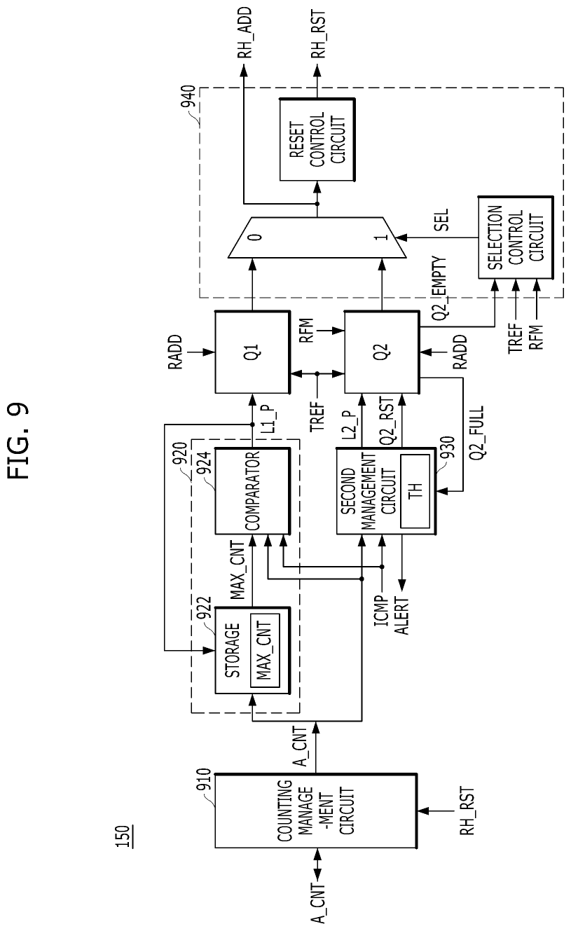

FIG. 9 is a detailed block diagram illustrating the row-hammer control circuit 150 in accordance with a third embodiment of the present invention. In the third embodiment of the present invention, the configuration of the row-hammer control circuit 150 is described when a first management circuit and a second management circuit operate independently of each other.

Referring to FIG. 9, the row-hammer control circuit 150 may include a counting management circuit 910, a first queue Q1, a second queue Q2, a first management circuit 920, a second management circuit 930, and an output control circuit 940.

The configuration and operation of the counting management circuit 910, the first queue Q1, the second queue Q2, the first management circuit 920, the second management circuit 930, and the output control circuit 940 of FIG. 9 may be substantially the same as those of FIG. 7. However, there is a difference in that both the first management circuit 920 and the second management circuit 930 receive the internal comparison signal ICMP. Hereinafter, FIG. 9 will be described based on a different configuration from FIG. 7.

The first management circuit 920 may include a storage 922 and a comparator 924. The storage 922 may store the counting data A_CNT as the maximum value MAX_CNT according to a first comparison decision signal L1_P. The comparator 924 may compare the value of the counting data A_CNT with the maximum value MAX_CNT according to the internal comparison signal ICMP. The comparator 924 may activate the first comparison decision signal L1_P when the value of the counting data A_CNT is greater than the maximum value MAX_CNT. The first queue Q1 may store the row address RADD into its field, as the first sampling address RADD_MAX, according to the first comparison decision signal L1_P.

The second management circuit 930 may compare the value of counting data A_CNT with the pre-stored specific threshold value TH according to the internal comparison signal ICMP. When the value of the counting data A_CNT is greater than or equal to the specific threshold value TH, the second management circuit 930 may activate a third comparison decision signal L2_P. The second queue Q2 may insert a new field and store the row address RADD as one of the second sampling addresses RADD_Q2 # in the inserted field, according to the third comparison decision signal L2_P. The second management circuit 930 may generate the alert signal ALERT according to a full-state signal Q2_FULL provided from the second queue Q2.

Hereinafter, a method of managing the first queue Q1 and the second queue Q2 according to the third embodiment will be described with reference to FIGS. 6B, 8B, 9 and 10.

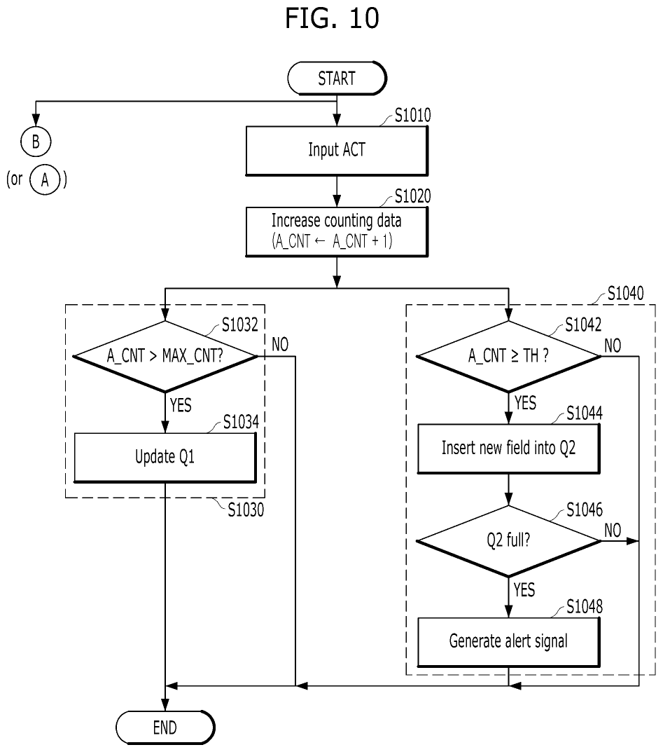

FIG. 10 is a flowchart for describing an operation of the memory device 100 including the row-hammer control circuit 150 of FIG. 9.

Referring to FIG. 10, the active command ACT is input together with the row address RADD (at S1010). The internal signal generation circuit 176 may sequentially generate the internal read signals IRD, the internal comparison signal ICMP, and the internal light signals IWT according to the active command ACT.

The second column control circuit 134 may read the counting data A_CNT from the row-hammer cells RHC coupled to the activated row according to the internal read signal IRD. The counting management circuit 910 of the row-hammer control circuit 150 may update the counting data A_CNT by increasing the value of the counting data A_CNT by “+1” (at S1020). After that, the second column control circuit 134 may write back the updated counting data A_CNT to the row-hammer cells RHC in the row indicated by the row address RADD, according to the internal write signal IWT.

The operation S1030 of the first management circuit 920 and the operation S1040 of the second management circuit 930 may be performed independently of each other.

The first management circuit 920 may manage the first queue Q1 according to the counting data A_CNT (at S1030). The first management circuit 920 may compare the counting data A_CNT with the maximum value MAX_CNT according to the internal comparison signal ICMP (at S1032). When the value of the counting data A_CNT is greater than the maximum value MAX_CNT (“YES” in S1032), the first management circuit 920 may activate the first comparison decision signal L1_P, and accordingly, the first queue Q1 may update the field by storing the input row address RADD (at S1034). In addition, the first management circuit 920 may update the counting data A_CNT as the maximum value MAX_CNT according to the first comparison decision signal L1_P. When the value of the counting data A_CNT is less than or equal to the maximum value MAX_CNT (“NO” in S1032), the operation may be terminated without an additional update operation of the first management circuit 920 and the second management circuit 930.

The second management circuit 930 may manage the second queue Q2 according to the counting data A_CNT (at S1040). The second management circuit 930 may compare the counting data A_CNT with the specific threshold value TH according to the internal comparison signal ICMP (at S1042). When the value of the counting data A_CNT is greater than or equal to the specific threshold value TH (“YES” in S1042), the second management circuit 930 may activate the third comparison decision signal L2_P. Thus, the second queue Q2 may insert a new field and store the row address RADD as one of the second sampling addresses RADD_Q2 # in the inserted field, according to the third comparison decision signal L2_P (at S1044). At this time, when the second queue Q2 is full (“YES” in S1046), the second management circuit 930 may generate the alert signal ALERT (at S1048). The alert signal ALERT may be provided to the memory controller through the internal data bus. On the other hand, when the value of the counting data A_CNT is less than the specific threshold value TH (“NO” in S1042), the operation may be terminated without an additional update operation of the first management circuit 920 and the second management circuit 930.

Referring to FIG. 8B, the refresh management command RFM is input (at S850). The output control circuit 940 may output one of the second sampling addresses RADD_Q2 # stored in the second queue Q2 as the row-hammer address RH_ADD according to the refresh management command RFM (at S860). After that, the second queue Q2 may initialize a field in which the second sampling address output according to the refresh management command RFM is stored. The row control circuit 120 may perform a target refresh operation to refresh one or more adjacent rows corresponding to the row-hammer address RH_ADD according to the refresh management command RFM (at S860). After the row-hammer address RH_ADD is output, the output control circuit 940 may activate the counting reset signal RH_RST, and the counting management circuit 910 may initialize the counting data A_CNT (at S870). The second column control circuit 134 may write back the initialized counting data A_CNT to the row-hammer cells RHC in the row indicated by the row-hammer address RH_ADD, according to the internal write signal IWT.

On the other hand, when the normal refresh command REF is input (“NO” in S882), the row control circuit 120 may perform a normal refresh operation that sequentially refreshes the plurality of rows WL (at S884).

The target command generation circuit 175 may generate the target refresh command TREF whenever the number of inputs of the normal refresh command REF reaches a predetermined number of times or reaches a certain condition (“YES” in S882). The output control circuit 940 may select one from the row addresses stored in the first queue Q1 and the second queue Q2 according to a state of the second queue Q2 when the target refresh command TREF is input. For example, when the target refresh command TREF is input and the empty signal Q2_EMPTY is activated (“YES” in S890), the output control circuit 940 may output the first sampling address RADD_MAX stored in the first queue Q1 as the row-hammer address RH_ADD (at S892). Thereafter, the first queue Q1 may initialize its field according to the target refresh command TREF. The row control circuit 120 may perform a target refresh operation to refresh one or more adjacent rows corresponding to the row-hammer address RH_ADD according to the target refresh command TREF (at S892). Meanwhile, when the target refresh command TREF is input and the empty signal Q2_EMPTY is deactivated (“NO” in S890), the output control circuit 940 may output one of the second sampling address RADD_Q2# stored in the second queue Q2 as the row-hammer address RH_ADD (at S860). The row control circuit 120 may perform a target refresh operation to refresh one or more adjacent rows corresponding to the row-hammer address RH_ADD according to the target refresh command TREF (at S860).

After the row-hammer address RH_ADD is output, the output control circuit 940 may activate the counting reset signal RH_RST, and the counting management circuit 910 may initialize the counting data A_CNT (at S870). The second column control circuit 134 may write back the initialized counting data A_CNT to the row-hammer cells RHC in the row indicated by the row-hammer address RH_ADD, according to the internal write signal IWT.

Depending on an embodiment, the memory device 100 including the row-hammer control circuit 150 of FIG. 9 may perform a refresh operation as described in FIG. 6B. That is, as shown in FIG. 6B, when the refresh management command RFM is input (at S650), the output control circuit 940 may output one of the second sampling addresses (ADD_Q2 # stored in the second queue Q2 as the row-hammer address RH_ADD (at S660). On the other hand, when the target refresh command TREF is generated according to the normal refresh command REF (“YES” in S682). The output control circuit 940 may output the first sampling address RADD_MAX stored in the first queue Q1 as the row-hammer address RH_ADD according to the target refresh command TREF (at S690).

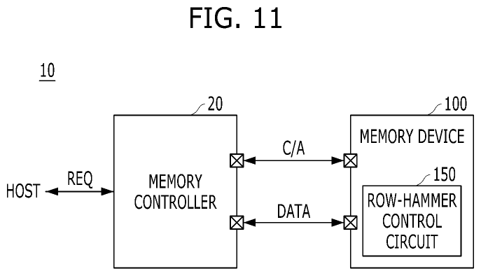

FIG. 11 is a block diagram illustrating a memory system 10 in accordance with an embodiment of the present invention.

Referring to FIG. 11, the memory system 10 may include a memory controller 20 and the memory device 100.

The memory controller 20 may control an overall operation of the memory system 10 and control a data exchange between a host and the memory device 100. The memory controller 20 may generate a command/address signal C/A and provide it to the memory device 100 according to a request REQ from the host. According to an embodiment, the memory controller 20 may provide a clock to the memory device 100 together with the command/address signal C/A. The memory controller 20 may provide data DATA corresponding to the request REQ provided from the host to the memory device 100. The memory controller 20 may provide data DATA read from the memory device 100 to the host.

The command/address signal C/A provided from the memory controller 20 to the memory device 100 may include an active command ACT, a precharge command PCG, a normal refresh command REF, a refresh management command RFM, a read command RD, a write command WT, and the like. The memory controller 20 may issue the normal refresh command REF that instructs a normal refresh operation between the requested operations from the host. The memory controller 20 may apply the normal refresh command REF so that all rows are sequentially refreshed within a refresh time (tREF) defined in the specification. Furthermore, the memory controller 20 may issue the refresh management command RFM every preset time defined in the specification or issue the refresh management command RFM every time the number of issuances of the active command ACT reaches a preset number defined in the specification.

The memory device 100 may have substantially the same configuration as the memory device 100 described in FIG. 1. In particular, the memory device 100 may include a row-hammer control circuit 150 including a first queue Q1 and a second queue Q2. In an embodiment of the present invention, when the active command ACT is input, the memory device 100 may read counting data A_CNT from a row indicated by a row address. The row-hammer control circuit 150 may store the corresponding row address in the first queue Q1 according to a comparison result of the counting data A_CNT and a maximum value MAX_CNT, and store the corresponding row address in the second queue Q2 according to a comparison result of the counting data A_CNT and a specific threshold value TH. The row-hammer control circuit 150 may generate an alert signal ALERT when the second queue Q2 is full.

The memory controller 20 may provide the refresh management commands RFM to the memory device 100 as the command/address signal C/A as many times according to the alert signal ALERT. The row-hammer control circuit 150 may select, as the row-hammer address RH_ADD, one of the row addresses stored in the first queue Q1 and the second queue Q2. The memory device 100 may perform a target refresh operation to refresh one or more adjacent rows corresponding to the row-hammer address RH_ADD according to the refresh management command RFM or an internally generated target refresh command TREF. As described above, in the embodiments of the present invention, the memory controller 20 may additionally issue the refresh management command RFM whenever the alert signal ALERT is received from the memory device. Accordingly, it is possible to maximize the defense capability to the row-hammer attack.

Various embodiments of the present disclosure have been described in the drawings and specification. Although specific terminologies are used here, the terminologies are only to describe the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein. The embodiments may be combined to form additional embodiments.

It should be noted that although the technical spirit of this disclosure has been described in connection with embodiments thereof, this is merely for description purposes and should not be interpreted as limiting. It should be appreciated by one of ordinary skill in the art that various changes may be made thereto without departing from the technical spirit of the disclosure and the following claims. Furthermore, the embodiments may be combined to form additional embodiments.

For example, for the logic gates and transistors provided as examples in the above-described embodiments, different positions and types may be implemented depending on the polarity of the input signal.

What is claimed is:

1. A memory device comprising:
a memory cell region including a plurality of rows;
a row-hammer control circuit including first and second queues, and configured to:
read counting data from a row indicated by a row address according to an active command,
store the row address in the first queue according to a comparison result of the counting data and a first set value,
store the row address in the second queue according to a comparison result of the counting data and a second set value, and
select, as a row-hammer address according to a refresh management command or a target refresh command, one of the row addresses stored in the first queue and the second queue; and
a row control circuit configured to refresh one or more rows corresponding to the row-hammer address according to the refresh management command or the target refresh command.

2. The memory device of claim 1,
wherein the first set value is a maximum value among the counting data read from the respective rows, and
wherein the first queue is configured to have a single field for storing therein the row address corresponding to the maximum value.

3. The memory device of claim 1, wherein the second queue is configured to have a plurality of fields for respectively storing therein the row addresses indicating rows each corresponding to the counting data equal to or greater than the second set value.

4. The memory device of claim 3, wherein the row-hammer control circuit is further configured to output an alert signal to an external device when the second queue is full.

5. The memory device of claim 1,
wherein the row-hammer control circuit is further configured to update the counting data as the first set value when a value of the counting data is greater than the first set value,
wherein the row-hammer control circuit stores the row address into the first queue when the value of the counting data is greater than the first set value, and
wherein the row-hammer control circuit stores the row address into the second queue when the value of the counting data is greater than or equal to the second set value.

6. The memory device of claim 1, wherein the row-hammer control circuit selects:
the row address stored in the second queue according to the refresh management command, and
the row address stored in the first queue according to the target refresh command.

7. The memory device of claim 1, wherein the row-hammer control circuit selects:
the row address stored in the second queue according to the refresh management command,
the row address stored in the second queue, when the second queue is not empty, according to the target refresh command, and
the row address stored in the first queue, when the second queue is empty, according to the target refresh command.

8. The memory device of claim 1, further comprising:
a command decoder configured to generate the refresh management command and a normal refresh command by decoding a command; and
a target command generation circuit configured to generate the target refresh command based on the normal refresh command.

9. The memory device of claim 1, wherein the row-hammer control circuit includes:
a first management circuit configured to update the counting data as the first set value and store the row address into the first queue, when a value of the counting data is greater than the first set value;
a second management circuit configured to store the row address into the second queue when the value of the counting data is greater than or equal to the second set value and configured to generate an alert signal when the second queue is full; and
an output control circuit configured to select the row-hammer address according to the refresh management command or the target refresh command.

10. The memory device of claim 9, further comprising a counting management circuit configured to update the counting data according to the active command and configured to initialize the counting data after the refreshing.

11. An operating method of a memory device, the method comprising:
reading counting data from a row indicated by a row address according to an active command;
updating the counting data as a first set value and storing the row address into a first queue, when a value of the counting data is greater than the first set value;
storing the row address into a second queue when the value of the counting data is less than or equal to the first set value but greater than or equal to a second set value; and
refreshing, according to a refresh management command or a target refresh command, one or more rows corresponding to a selected row address of the row addresses stored in the first queue and the second queue.

12. The operating method of claim 11, wherein the storing the row address into the second queue includes storing the row address into the second queue when the counting data is less than or equal to the first set value but greater than or equal to the second set value occurs a preset number of times.

13. The operating method of claim 11, further comprising generating an alert signal when the second queue is full.

14. The operating method of claim 11, further comprising:
generating the refresh management command and a normal refresh command by decoding a command; and
generating the target refresh command based on the normal refresh command.

15. The operating method of claim 11, wherein the refreshing includes:
refreshing, according to the refresh management command, the rows corresponding to the row address stored in the second queue; and
refreshing, according to the target refresh command, the rows corresponding to the row address stored in the first queue.

16. The operating method of claim 11, further comprising:
updating the counting data and writing back the updated counting data to the row indicated by the row address, according to the active command; and
initializing the counting data and writing back the initialized counting data to the row indicated by the selected row address.

17. An operating method of a memory device, the operating method comprising:
reading counting data from a row indicated by a row address according to an active command;
storing the row address into a second queue when a value of the counting data is greater than or equal to a second set value;
updating the counting data as a first set value and storing the row address into a first queue, when the value of the counting data is less than the second set value but greater than the first set value; and
refreshing, according to a refresh management command or a target refresh command, one or more rows corresponding to one of the row addresses stored in the first queue and the second queue.

18. The operating method of claim 17, wherein the refreshing includes:
refreshing, according to the refresh management command, the rows corresponding to the row address stored in the second queue;
refreshing, according to the target refresh command, the rows corresponding to the row address stored in the second queue when the second queue is not empty; and
refreshing, according to the target refresh command, the rows corresponding to the row address stored in the first queue when the second queue is empty.

19. An operating method of a memory device, the operating method comprising:
reading counting data from a row indicated by a row address according to an active command;
updating the counting data as a first set value and storing the row address into a first queue, when a value of the counting data is greater than the first set value;
storing the row address into a second queue when the value of the counting data is greater than or equal to a second set value; and
refreshing, according to a refresh management command or a target refresh command, one or more rows corresponding to one of the row addresses stored in the first queue and the second queue.

20. The operating method of claim 19, wherein the refreshing includes:
refreshing, according to the refresh management command, the rows corresponding to the row address stored in the second queue;
refreshing, according to the target refresh command, the rows corresponding to the row address stored in the second queue when the second queue is not empty; and
refreshing, according to the target refresh command, the rows corresponding to the row address stored in the first queue when the second queue is empty.

21. The operating method of claim 19, wherein the refreshing includes:
refreshing, according to the refresh management command, the rows corresponding to the row address stored in the second queue; and
refreshing, according to the target refresh command, the rows corresponding to the row address stored in the first queue.

22. A memory system comprising:
a memory controller configured to provide an active command with a row address, or a normal refresh command, or a refresh management command; and
a memory device configured to:
read counting data from a row indicated by the row address according to the active command,
store the row address in a first queue according to a comparison result of the counting data and a first set value,
store the row address in a second queue according to a comparison result of the counting data and a second set value, and
refresh, according to a refresh management command or a target refresh command, one or more rows corresponding to one of the row addresses stored in the first queue and the second queue.

23. The memory system of claim 22, wherein the memory device is further configured to generate the target refresh command based on the normal refresh command.

24. The memory system of claim 22,
wherein the memory device is further configured to generate an alert signal when the second queue is full, and
wherein the memory controller provides the refresh management command every preset time, or each time the active command is provided a preset number of times, or according to the alert signal.

25. The memory system of claim 22,
wherein the memory device is further configured to update the counting data as the first set value when a value of the counting data is greater than the first set value,
wherein the memory device stores the row address into the first queue when the value of the counting data is greater than the first set value, and
wherein the memory device stores the row address into the second queue when the value of the counting data is greater than or equal to the second set value.

26. The memory system of claim 22, wherein the memory device refreshes the rows corresponding to:
the row address stored in the second queue according to the refresh management command, and
the row address stored in the first queue according to the target refresh command.

27. The memory system of claim 22, wherein the memory device refreshes the rows corresponding to:
the row address stored in the second queue according to the refresh management command,
the row address stored in the second queue, when the second queue is not empty, according to the target refresh command, and
the row address stored in the first queue, when the second queue is empty, according to the target refresh command.
